(19) United States
(12) Patent Application Publication
(10) Pub. No.: US 2010/0192976 A1
(43) Pub. Date: Aug. 5, 2010

(54) APPARATUS FOR CLEANING A MEMBRANE MODULE AND A METHOD THEREFOR

(76) Inventors: Kwang-Jin Lee, Gyeonggi-do (KR); Sung-Hak Choi, Gyeonggi-do (KR); Moo-Seok Lee, Seoul (KR)

Correspondence Address: BIRCH STEWART KOLASCH & BIRCH, PO BOX 747, FALLS CHURCH, VA, 22040-0747, US

(21) Appl. No.: 12/669,392

(22) PCT Filed: Aug. 11, 2008
(86) PCT No.: PCT/KR08/04656

§ 371 Date: Jan. 15, 2010

(30) Foreign Application Priority Data
Aug. 16, 2007 (KR) 10-2007-0082444

(51) Int. Cl. B08B 7/04; B08B 3/00

(52) U.S. Cl. 134/10; 134/95.1; 134/26; 134/27

(57) ABSTRACT

Disclosed are an apparatus for cleaning a membrane module and a method therefor, which can minimize consumption of chemicals required to clean the membrane module while maximizing a recovery cleaning rate of the membrane module without completely stopping a water treatment operation. The cleaning apparatus includes a first flushing bath for flushing a membrane module transferred from a water treatment tank, and a first chemical cleaning bath for cleaning the membrane module, which has been completely flushed and transferred from the first flushing bath, by use of a first chemical solution.

### TECHNICAL FIELD

The present invention relates to an apparatus for a cleaning membrane module and a method therefor, and more particularly, to an apparatus for a cleaning membrane module and a method therefor, which can minimize consumption of chemicals required to clean the membrane module while maximizing a recovery cleaning rate of the membrane module without completely stopping a water treatment operation.

### BACKGROUND ART

As compared to separation methods using heating or phase variation, separation methods using separating membranes have many advantages. One of the advantages is that a desired quality of water can be stably achieved according to the size of fine pores of separating membranes, resulting in an improvement in process reliability. The use of separating membranes, further, eliminates separate operations, such as heating and the like, and therefore, the separating membranes can be widely used in separation processes using microorganisms and the like that tend to be affected by, for example, heating.

Such separating membranes include flat-sheet membranes and hollow-fiber membranes. In the case of a hollow-fiber membrane module, a bundle of hollow-fiber membranes are used to perform a separating operation. Although such a hollow-fiber membrane module typically has been widely used in precision filtering fields, such as production of sterile water, drinking water, ultra-pure water and the like, in recent years, an application range thereof is increasingly expanded to sewage/waste water treatments, solid/liquid separation in sanitation facilities, removal of Suspended Solids (SS) in industrial waste water, filtering of river water, filtering of industrial water and filtering of pool water, and the like.

One example of such a hollow-fiber membrane module is an immersion type hollow-fiber membrane module wherein the hollow-fiber membrane module is directly immersed in a cleaning bath in which fluid to be treated is received, and a negative pressure is applied to the hollow-fiber membrane module so as to allow only fluid to selectively pass through hollow fibers, enabling separation of solid components, such as impurities or slurries or the like. The immersion type hollow-fiber membrane module is mainly used in the unit of a cassette in which a multiplicity of modules is coupled to a frame. The immersion type hollow-fiber membrane module has advantages of reduced manufacturing costs and eliminating facilities for circulation of fluid, resulting in reductions in facility costs and operating costs.

When sewage/waste water in which membrane contaminants including solid components are suspended is treated using the above-described immersion type hollow-fiber membrane module, however, the membrane is gradually contaminated by the membrane contaminants, causing a significant deterioration in permeation performance of the membrane according to the progress of water treatment. The various membrane contaminants cause membrane contamination in different manners and therefore, there also exits a need for various methods for cleaning contaminated membranes in different manners.

Cleaning of contaminated membranes may be classified, according to cleaning purposes, into maintenance cleaning and recovery cleaning.

Maintenance cleaning is a cleaning method performed for a short time while water treatment is performed using a hollow-fiber membrane module in a water-treatment tank or during a temporary stoppage of the water treatment. A main purpose of the maintenance cleaning is to maintain good permeation performance of a membrane. The maintenance cleaning is mainly performed via physical cleaning. Here, physical cleaning may be classified into backwashing and aeration. Backwashing causes air or water to flow backward through a membrane during a temporary stoppage of water treatment, thereby removing impurities adhered to a surface of the membrane. Aeration creates bubbles below a membrane and causes the bubbles to rise, thereby removing impurities adhered to a surface of the membrane not only using the bubbles, but also via rising or circulation of water received in a water treatment tank.

Recovery cleaning is a cleaning method performed for a relatively long time when a hollow-fiber membrane module exhibits serious deterioration in permeation performance of a membrane due to membrane contaminants accumulated as water treatment is performed for a long time in a water treatment tank. A main purpose of the recovery cleaning is to recover permeation performance of the membrane.

Conventionally, recovery cleaning is performed via a chemical cleaning method using an acid solution, such as HCl, HNO₃ or citric acid or the like, and/or a base solution, such as NaOH or NaOCl or the like. Now, a typical example of recovery cleaning will be described in detail.

First, application of a negative pressure to a plurality of cassettes immersed in a water treatment tank, and more particularly, a plurality of hollow-fiber membrane modules, is stopped, causing complete stoppage of a water treatment operation. Then, feed water filled in a water treatment tank is completely discharged and the hollow-fiber membrane modules are subjected to flushing for about 30 minutes. After completion of the flushing, base and acid solutions are sequentially supplied into the water treatment tank, performing chemical cleaning on the hollow-fiber membrane modules. The chemical cleaning is performed for about 6 hours for each of base and acid solution cleaning. In this case, the entire base solution must be discharged from the water treatment tank prior to beginning chemical cleaning using an acid solution, and, in consideration of environmental problems, it is essential to neutralize the base solution to be discharged. Accordingly, discharge of the base solution requires a corresponding amount of an acid solution required to neutralize the base solution. Similarly, after completion of chemical cleaning using an acid solution, the used acid solution must be discharged from the water treatment tank and this requires a corresponding amount of a base solution required to neutralize the acid solution.

Once, for example, the acid solution is completely discharged from the water treatment tank after completion of the chemical cleaning as described above, the hollow-fiber membrane modules are subjected to flushing for about 30 minutes, completing recovery cleaning.

In the above-described recovery cleaning, the hollow-fiber membrane modules of all cassettes present in the water treatment tank are cleaned together, and therefore, a total time required to clean all the cassettes can be reduced. However, this has a serious problem in that a water treatment operation in the water treatment tank must be completely stopped during implementation of the recovery cleaning.

Moreover, neutralizing the acid and base solutions used in the chemical cleaning requires expensive chemicals, resulting in high cleaning costs.

### DISCLOSURE

### Technical Problem

Therefore, the present invention has been made in view of the above problems, and it is an object of the present invention to provide an apparatus for cleaning membrane modules and a cleaning method using the same, which can substantially prevent the previously described conventional problems and limits.

It is a further object of the present invention to provide an apparatus for cleaning membrane modules and a cleaning method using the same, which can maximize a recovery cleaning rate with respect to membrane modules of all cassettes immersed in a water treatment tank without stoppage of a water treatment operation.

It is a still further object of the present invention to provide an apparatus for cleaning membrane modules and a cleaning method using the same, which can minimize consumption of chemicals required for recovery cleaning of membrane modules.

It is a still further object of the present invention to provide an apparatus for cleaning membrane modules and a cleaning method using the same, which can achieve maximized cleaning effects.

Other features and advantages of the present invention will be illustrated in the following description and be obviously from the description. Further features and advantages of the present invention will be understood from exemplary embodiments. The above and other objects and other advantages of the present invention will be realized and accomplished by the structure specified in the detailed description and claims as well as in the accompanying drawings.

### Technical Solution

In accordance with an aspect of the present invention, the above and other objects can be accomplished by the provision of an apparatus for cleaning a membrane module comprising: a first flushing bath for flushing a membrane module transferred from a water treatment tank; and a first chemical cleaning bath for cleaning the membrane module, which has been completely flushed and transferred from the first flushing bath, by use of a first chemical solution.

In accordance with a further aspect of the present invention, there is provided a method for cleaning a membrane module comprising: transferring a membrane module from a water treatment tank; flushing the membrane module, transferred from the water treatment tank, in a first flushing bath; and cleaning the membrane module, which has been flushed and transferred from the first flushing bath, in a first chemical cleaning bath by use of a first chemical solution.

In accordance with a still further aspect of the present invention, there is provided a method for cleaning a membrane module comprising: flushing a first membrane module, transferred from a water treatment tank, in a first flushing bath; and cleaning the flushed first membrane module in a first chemical cleaning bath by use of a first chemical solution; and flushing a second membrane module, transferred from the water treatment tank, in the first flushing bath during the cleaning of the first membrane module in the first chemical cleaning bath.

It should be understood that both the above general techniques and the following detailed description are given for the purpose of illustration or description of the present invention and are made for a more detailed explanation about the invention disclosed in the claims.

### ADVANTAGEOUS EFFECTS

With an apparatus for cleaning membrane modules and a cleaning method using the same according to the present invention, a recovery cleaning rate of the membrane modules can be maximized even without completely stopping a water treatment operation in a water treatment tank.

Further, according to the present invention, chemicals used in chemical cleaning of any one membrane module cassette can be used in next chemical cleaning of another membrane module cassette. This can reduce the total amount of chemicals used for recovery cleaning and eliminate consumption of additional chemicals for neutralizing processes, resulting in a reduction in cleaning costs. Furthermore, the number of neutralizing processes that are essentially required upon discharge of chemicals used in recovery cleaning can be minimized, resulting in enhanced cleaning operation efficiency and cleaning rate.

### DESCRIPTION OF DRAWINGS

The above and other objects, features and other advantages of the present invention will be more clearly understood from the following detailed description taken in conjunction with the accompanying drawings, in which:

FIG. 1 is a view schematically illustrating an apparatus for cleaning membrane modules according to a first embodiment of the present invention;

FIG. 2 is a view schematically illustrating an apparatus for cleaning membrane modules according to a second embodiment of the present invention;

FIG. 3 is a view schematically illustrating an apparatus for cleaning membrane modules according to a third embodiment of the present invention;

FIG. 4 is a view illustrating a cleaning timing of each membrane module cassette to be cleaned by the apparatus for cleaning membrane modules according to the first embodiment of the present invention;

FIGS. 5 and 6 are views schematically illustrating different systems for neutralizing acid and base solutions used in chemical cleaning according to the embodiments of the present invention;

FIG. 7 is a view schematically illustrating a fluid circulating device for circulating fluid, such as a chemical solution and the like, used in the apparatus for cleaning membrane modules according to the present invention; and

FIG. 8 is a view schematically illustrating a fluid oscillator mounted in a chemical cleaning bath according to an embodiment of the present invention.

### BEST MODE

Hereinafter, preferred embodiments of the present invention will be described with reference to the accompanying drawings.

Although the preferred embodiments of the present invention will be disclosed for illustrative purposes, those skilled in the art will appreciate that various modifications, additions and substitutions are possible, without departing from the scope and spirit of the invention as disclosed in the accompanying claims.

For the convenience of explanation of the present invention, although it is assumed that five membrane module cassettes are immersed in a single water treatment tank to perform a water treatment operation, it will be appreciated that the number of membrane module cassettes to be immersed in a single water treatment tank can be changed according to the size of the tank and the amount of feed water to be treated. Meanwhile, each membrane module cassette is configured such that a plurality of membrane modules is mounted to a frame. Although immersion or transfer of membrane modules into or from the water treatment tank is performed on a per cassette basis according to the preferred embodiments of the present invention, the immersion and transfer may be performed on an individual membrane module basis.

It is understood that membrane modules to be treated by recovery cleaning using the apparatus and method of the present invention include both flat-sheet membrane modules and hollow-fiber membrane module.

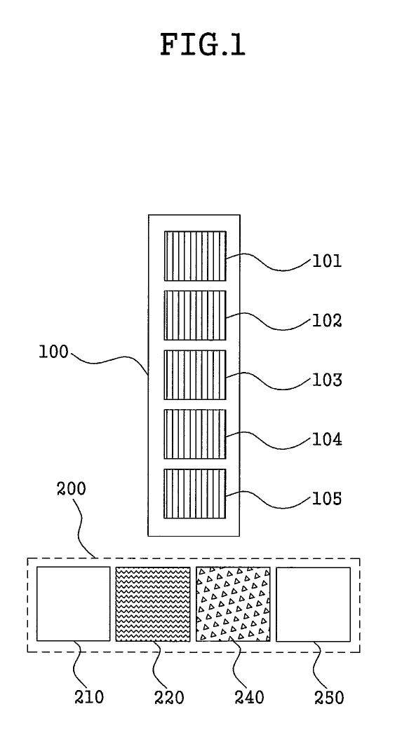

FIG. 1 is a view schematically illustrating an apparatus for cleaning membrane modules according to a first embodiment of the present invention.

As shown in FIG. 1, the apparatus for cleaning membrane modules according to the first embodiment of the present invention includes a first flushing bath 210, a first chemical cleaning bath 220, a second chemical cleaning bath 240, and a second flushing bath 250. Hereinafter, a method for performing recovery cleaning of membrane modules using the above-described cleaning apparatus will be described in detail.

First, membrane modules are immersed in a water treatment tank 100 and are subjected to a water treatment operation. On the basis of results of the water treatment operation, a first membrane module cassette 101, which has been determined to have serious contamination, is transferred from the water treatment tank 100. The transferred first membrane module cassette 101 is subjected to flushing in the first flushing bath 210 for about 30 minutes. Here, the flushing time of 30 minutes is simply given as an exemplary time, and a flushing time and chemical cleaning time that will be described hereinafter must be adjusted according to the number and size of membrane modules and the like.

After completion of the flushing, the first membrane module cassette 101 is transferred from the first flushing bath 210 and then, is immersed for about 6 hours in the first chemical cleaning bath 220, in which a first chemical solution is received, so as to be cleaned by the first chemical solution. According to embodiments of the present invention, although chemical cleaning for membrane modules is performed in an immersion cleaning manner, the chemical cleaning of the present invention is not limited to the immersion cleaning manner, and for example, may be performed via an injection cleaning manner. It is understood that the injection cleaning manner is within the scope of the present invention.

During the cleaning of the first membrane module cassette 101 in the first chemical cleaning bath 220, a second membrane module cassette 102, which has been immersed in the water treatment tank 100 and subjected to the water treatment operation, is transferred from the water treatment tank 100, and then, is subjected to flushing in the first flushing bath 210 for about 30 minutes.

After completion of the chemical cleaning for the first membrane module cassette 101, the first membrane module cassette 101 is transferred from the first chemical cleaning bath 220, and then, is immersed for about 6 hours in the second chemical cleaning bath 240, in which a second chemical solution is received, so as to be cleaned by the second chemical solution.

Simultaneously with the cleaning of the first membrane module cassette 101 in the second chemical cleaning bath 240, the second membrane module cassette 102, which has been flushed in the first flushing bath 210, is immersed for about 6 hours in the first chemical cleaning bath 220 so as to be cleaned by the first chemical solution. In turn, during the cleaning of the second membrane module cassette 102 in the first chemical cleaning bath 220, a third membrane module cassette 103, which has been immersed in the water treatment tank 100 and subjected to the water treatment operation, is transferred from the water treatment tank 100, and then, is subjected to flushing in the first flushing bath 210 for about 30 minutes.

After completion of the cleaning using the second chemical solution, the first membrane module cassette 101 is transferred from the second chemical cleaning bath 240, and then, is subjected to flushing in the second flushing bath 250 for about 30 minutes.

During the flushing of the first membrane module cassette 101 in the second flushing bath 250, the second membrane module cassette 102, which has been cleaned by the first chemical solution in the first chemical cleaning bath 220, is immersed in the second chemical cleaning bath 240 for about 6 hours so as to be cleaned by the second chemical solution. In this case, of course, the flushing for the first membrane module cassette 101 in the second flushing bath 250 is completed faster than the chemical cleaning for the second membrane module cassette 102 in the second chemical cleaning bath 240.

Simultaneously with the cleaning of the second membrane module cassette 102 in the second chemical cleaning bath 240, the third membrane module cassette 103, which has been flushed in the first flushing bath 210, is immersed in the first chemical cleaning bath 220 for about 6 hours so as to be cleaned by the first chemical solution. During the cleaning of the third membrane module cassette 103 in the first chemical cleaning bath 220, a fourth membrane module cassette 104, which has been immersed in the water treatment tank 100 and subjected to the water treatment operation, is transferred from the water treatment tank 100, and then, is subjected to flushing in the first flushing bath 210 for about 30 minutes.

The above-described operations are repeated until recovery cleaning for a fifth membrane module cassette 105 is completed.

According to the above-described first embodiment of the present invention, each of the membrane module cassettes 101 to 105 may be additionally subjected to flushing in the first or second flushing bath 210 or 250 for about 30 minutes after being chemically cleaned in the first chemical cleaning bath 220 and before being moved into the second chemical cleaning bath 240.

Here, the first chemical solution is base solution, such as NaOH or NaOCl or the like, and the second chemical solution is acid solution, such as HCl, HNO3 or citric acid or the like. According to the embodiment of the present invention, although acid cleaning precedes base cleaning, but this order may be changed.

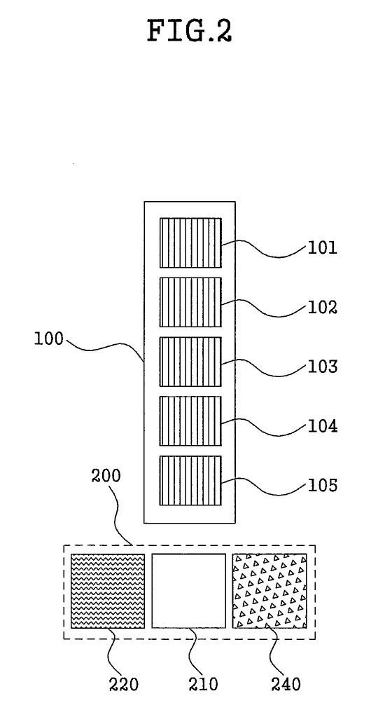

FIG. 2 is a view schematically illustrating an apparatus for cleaning membrane modules according to a second embodiment of the present invention.

As shown in FIG. 2, the apparatus for cleaning membrane modules according to the second embodiment of the present invention includes the flushing bath 210, the first chemical cleaning bath 220, and the second chemical cleaning bath 240. Hereinafter, a method for performing recovery cleaning of membrane modules using the above-described cleaning apparatus will be described in detail.

First, on the basis of results of a water treatment operation performed on membrane modules in the water treatment tank 100, the first membrane module cassette 101, which has been determined to have serious contamination, is transferred from the water treatment tank 100. The transferred first membrane module cassette 101 is subjected to flushing in the flushing bath 210 for about 30 minutes. Here, the flushing time of 30 minutes is simply given as an exemplary time, and a flushing time and chemical cleaning time must be adjusted according to the number and size of membrane modules and the like as described above.

After completion of the flushing, the first membrane module cassette 101 is transferred from the flushing bath 210 and then, is immersed for about 6 hours in the first chemical cleaning bath 220, in which the first chemical solution is received, so as to be cleaned by the first chemical solution. Note that the chemical cleaning of the present invention is not limited to the immersion cleaning manner, and for example, may be performed via an injection cleaning manner that is within the scope of the present invention.

During the cleaning of the first membrane module cassette 101 in the first chemical cleaning bath 220, the second membrane module cassette 102, which has been immersed in the water treatment tank 100 and subjected to the water treatment operation, is transferred from the water treatment tank 100, and then, is subjected to flushing in the first flushing bath 210 for about 30 minutes.

After completion of the chemical cleaning for the first membrane module cassette 101, the first membrane module cassette 101 is transferred from the first chemical cleaning bath 220, and then, is immersed for about 6 hours in the second chemical cleaning bath 240 in which the second chemical solution is received, so as to be cleaned by the second chemical solution.

During the cleaning of the first membrane module cassette 101 in the second chemical cleaning bath 240, the second membrane module cassette 102, which has been flushed in the first flushing bath 210, is immersed in the first chemical cleaning bath 220 for about 6 hours so as to be cleaned by the first chemical solution. In turn, during the cleaning of the second membrane module cassette 102 in the first chemical cleaning bath 220, the third membrane module cassette 103, which has been immersed in the water treatment tank 100 and subjected to the water treatment operation, is transferred from the water treatment tank 100, and then, is subjected to flushing in the first flushing bath 210 for about 30 minutes.

After completion of the cleaning using the second chemical solution, the first membrane module cassette 101 is transferred from the second chemical cleaning bath 240, the second membrane module cassette 102 is transferred from the first chemical cleaning bath 220 to thereby be immersed into the second chemical cleaning bath 240, and the third membrane module cassette 103 is transferred from the flushing bath 210 to thereby be immersed in the first chemical cleaning bath 220. Subsequently, the first membrane module cassette 101, transferred from the second chemical cleaning bath 240, is subjected to flushing in the flushing bath 210 for 30 minutes.

After completion of the flushing, the first membrane module cassette 101 is transferred from the flushing bath 210, and the fourth membrane module cassette 104, which has been immersed in the water treatment tank 100 and subjected to the water treatment operation, is transferred from the water treatment tank 100, and then, is subjected to flushing in the flushing bath 210 for about 30 minutes.

The above-described operations are repeated until recovery cleaning for the fifth membrane module cassette 105 is completed.

Each of the membrane module cassettes 101 to 105 may be additionally subjected to flushing in the flushing bath 210 for about 30 minutes after being chemically cleaned in the first chemical cleaning bath 220 and before being moved into the second chemical cleaning bath 240.

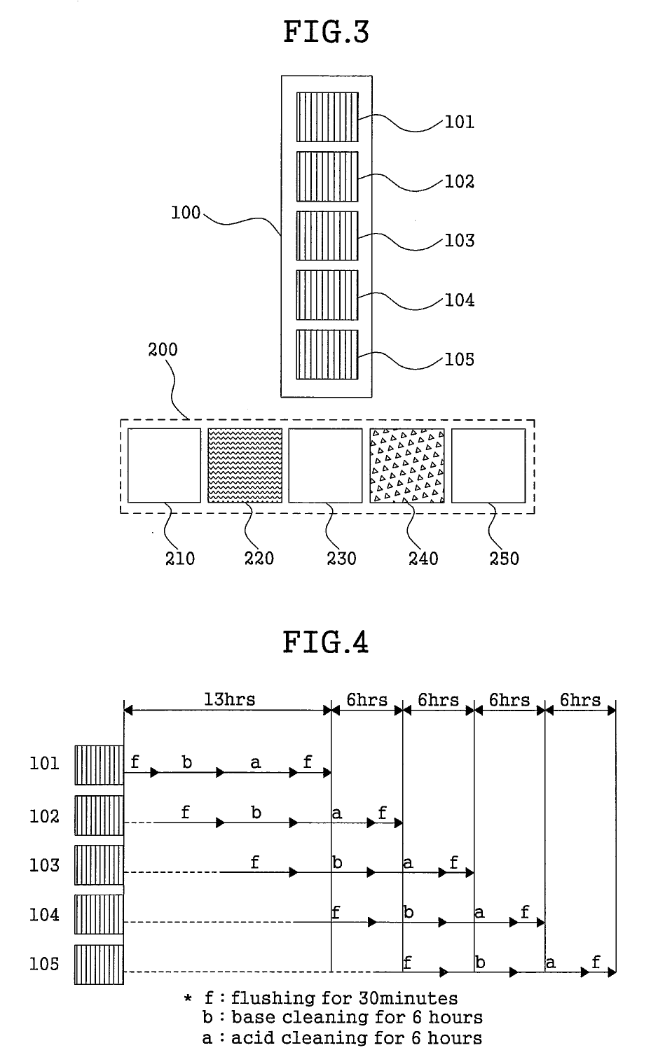

FIG. 3 is a view schematically illustrating an apparatus for cleaning membrane modules according to a third embodiment of the present invention.

As shown in FIG. 3, the apparatus for cleaning membrane modules according to the third embodiment of the present invention includes the first flushing bath 210, the first chemical cleaning bath 220, an intermediate flushing bath 230, the second chemical cleaning bath 240, and the second flushing bath 250. In consideration of the fact that the water treatment operation within the water treatment tank must not be completely stopped for recovery cleaning of membrane modules, it is preferred that the apparatus for cleaning membrane modules according to the third embodiment of the present invention be applied when at least six membrane module cassettes are subjected to the water treatment operation within the water treatment tank. Hereinafter, a method for performing recovery cleaning of membrane modules using the above-described cleaning apparatus will be described in detail.

First, on the basis of results of a water treatment operation performed on membrane modules in the water treatment tank 100, the first membrane module cassette 101, which has been determined to have serious contamination, is transferred from the water treatment tank 100. The transferred first membrane module cassette 101 is subjected to flushing in the first flushing bath 210 for about 30 minutes.

After completion of the flushing, the first membrane module cassette 101 is transferred from the first flushing bath 210 and then, is immersed for about 6 hours in the first chemical cleaning bath 220, in which the first chemical solution is received, so as to be cleaned by the first chemical solution. During the cleaning of the first membrane module cassette 101 in the first chemical cleaning bath 220, the second membrane module cassette 102, which has been immersed in the water treatment tank 100 and subjected to the water treatment operation, is transferred from the water treatment tank 100, and then, is subjected to flushing in the first flushing bath 210 for about 30 minutes.

After completion of the first chemical cleaning for the first membrane module cassette 101, the first membrane module cassette 101 is transferred from the first chemical cleaning bath 220, and then, is subjected to flushing in the intermediate flushing bath 230 for about 30 minutes. During the flushing of the first membrane module cassette 101 in the intermediate flushing bath 230, the second membrane module cassette 102, which has been flushed in the first flushing bath 210, is immersed in the first chemical cleaning bath 220 for about 6 hours, so as to be cleaned by the first chemical solution. In this case, naturally, the intermediate flushing for the first membrane module cassette 101 is completed faster than the first chemical cleaning for the second membrane module cassette 102. During the cleaning of the second membrane module cassette 102 in the first chemical cleaning bath 220, the third membrane module cassette 103, which has been immersed in the water treatment tank 100 and subjected to the water treatment operation, is transferred from the water treatment tank 100, and then, is subjected to flushing in the first flushing bath 210 for about 30 minutes.

After completion of the intermediate flushing for the first membrane module cassette 101, the first membrane module cassette 101 is transferred from the intermediate flushing bath 230 and then, is immersed for about 6 hours in the second chemical cleaning bath 240 in which the second chemical solution is received, so as to be cleaned by the second chemical solution.

During the cleaning of the first membrane module cassette 101 in the second chemical cleaning bath 240, the second membrane module cassette 102, which has been cleaned in the first chemical cleaning bath 220, is subjected to flushing in the intermediate flushing bath 230 for about 30 minutes. During the flushing of the second membrane module cassette 102 in the intermediate flushing bath 230, the third membrane module cassette 103, which has been flushed in the first flushing bath 210, is immersed in the first chemical cleaning bath 220 for about 6 hours, so as to be cleaned by the first chemical solution. In this case, naturally, the intermediate flushing for the second membrane module cassette 102 is completed faster than the first chemical cleaning for the third membrane module cassette 103. During the cleaning of the third membrane module cassette 103 in the first chemical cleaning bath 220, the fourth membrane module cassette 104, which has been immersed in the water treatment tank 100 and subjected to the water treatment operation, is transferred from the water treatment tank 100, and then, is subjected to flushing in the first flushing bath 210 for about 30 minutes.

After completion of the second chemical cleaning for the first membrane module cassette 101, the first membrane module cassette 101 is transferred from the second chemical cleaning bath 240 and then, is subjected to flushing in the second flushing bath 250 for about 30 minutes. During the flushing of the first membrane module cassette 101 in the second flushing bath 250, the second membrane module cassette 102, which has been flushed in the intermediate flushing bath 230, is immersed in the second chemical cleaning bath 240 for about 6 hours, so as to be cleaned by the second chemical solution. In this case, naturally, the flushing for the first membrane module cassette 101 is completed faster than the second chemical cleaning for the second membrane module cassette 102. During the cleaning of the second membrane module cassette 102 in the second chemical cleaning bath 240, the third membrane module cassette 103, which has been cleaned by the first chemical solution, is subjected to flushing in the intermediate flushing bath 230 for about 30 minutes. During the flushing of the third membrane module cassette 103 in the intermediate flushing bath 230, the fourth membrane module cassette 104, which has been flushed in the first flushing bath 210, is immersed in the first chemical cleaning bath 220 for about 6 hours, so as to be cleaned by the first chemical solution. In this case, naturally, the intermediate flushing for the third membrane module cassette 103 is completed faster than the first chemical cleaning for the fourth membrane module cassette 104. During the cleaning of the fourth membrane module cassette 104 in the first chemical cleaning bath 220, the fifth membrane module cassette 105, which has been immersed in the water treatment tank 100 and subjected to the water treatment operation, is transferred from the water treatment tank 100 and then, is subjected to flushing in the first flushing bath 210 for about 30 minutes.

The above-described operations are repeated until recovery cleaning for the last membrane module cassette is completed.

As described above, according to the embodiments of the present invention, each of the membrane module cassettes 101 to 105 is individually subjected to recovery cleaning. Accordingly, it is unnecessary to completely stop the water treatment operation in the water treatment tank 100 for recovery cleaning of the membrane modules, and this can maximize efficiency of the water treatment operation.

Meanwhile, conventional other methods for performing recovery cleaning on an individual membrane module basis include: i) a method wherein partitions are installed in a water treatment tank to physically separate each membrane module cassette from the others and to individually perform recovery cleaning for each membrane module cassette; and ii) a method wherein a single cleaning bath is provided separately from a water treatment tank and all membrane module cassettes are sequentially transferred from the water treatment tank and are sequentially subjected to recovery cleaning in the single cleaning bath. However, in these conventional methods, only after completing recovery cleaning for any one membrane module cassette, recovery cleaning for a next membrane module cassette can be initiated. Consequently, with respect to all the membrane module cassettes that have been subjected to a water treatment operation in a water treatment tank, these conventional methods results in an excessively low recovery cleaning rate.

On the other hand, with the apparatus and method for cleaning membrane modules according to the above-described first to third embodiments of the present invention, recovery cleaning operations for the respective membrane module cassettes can be performed in parallel. Accordingly, a total time required for recovery cleaning of all the membrane module cassettes can be remarkably reduced as compared with the above conventional methods.

For example, assuming that a total of five membrane module cassettes are received in a water treatment tank, and recovery cleaning for each membrane module cassette consists of flushing for 30 minutes, base cleaning for 6 hours, acid cleaning for 6 hours, and flushing for 30 minutes, in the case of the above conventional methods wherein recovery cleaning for any one membrane module cassette is initiated only after completion of recovery cleaning for a previous membrane module cassette, a total of 65 hours (13 hours×5) is theoretically required. On the other hand, according to the first embodiment of the present invention, a total of 37 hours is required. This will be described in more detail with reference to FIG. 4.

FIG. 4 is a view illustrating a cleaning timing of each membrane module cassette to be cleaned by the apparatus for cleaning membrane modules according to the first embodiment of the present invention.

As shown in FIG. 4, although recovery cleaning for each of the first to fifth membrane module cassettes 101 to 105 requires a total of 13 hours, recovery cleaning operations for the respective membrane module cassettes are performed in parallel and therefore, only 6 hours are added for each of the second to fifth membrane module cassettes 102 to 105. Consequently, a total time required to perform recovery cleaning on the first to fifth membrane module cassettes 101 to 105 is 37 hours.

Accordingly, with the apparatus and method for cleaning membrane modules according to the present invention, a recovery cleaning rate of membrane modules can be maximized even without stopping a water treatment operation in a water treatment tank.

Meanwhile, in the above conventional methods including: i) a method wherein partitions are installed in a water treatment tank to physically separate each membrane module cassette from the others and to individually perform recovery cleaning for each membrane module cassette; and ii) a method wherein a single cleaning bath is provided separately from a water treatment tank and all membrane module cassettes are sequentially transferred from the water treatment tank and are sequentially subjected to recovery cleaning in the single cleaning bath, it is still impossible to eliminate excessive consumption of the above mentioned chemicals as one problem of conventional technologies.

Specifically, in the above conventional methods, to perform a following operation after performing acid cleaning on any one membrane module cassette, acid solution used in the acid cleaning must be disposed of. However, since it is illegal to directly dispose of the acid solution to prevent environmental pollution, it is essential to neutralize the acid solution with the base solution. Similarly, to perform a following operation after performing base cleaning on any one membrane module cassette, a base solution used in the base cleaning must be neutralized by use of an acid solution prior to being disposed of. Accordingly, the above conventional methods have a problem in that chemicals for neutralizing processes are required in addition to a great amount of chemicals used in recovery cleaning.

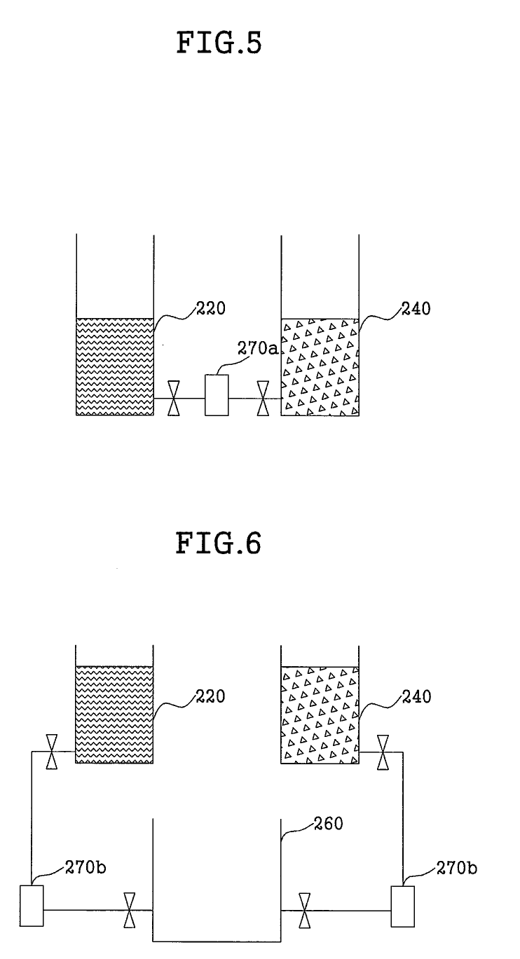

On the other hand, with the embodiments of the present invention, a relatively small amount of chemicals is used for recovery cleaning, and no chemicals for neutralizing processes are required. This will be described in more detail with reference to FIGS. 5 and 6.

FIGS. 5 and 6 are views schematically illustrating different systems for neutralizing acid and base solutions used in recovery cleaning according to the embodiments of the present invention.

According to an embodiment of the present invention, as shown in FIG. 5, the cleaning apparatus of the present invention includes a neutralizing pump 270a to pump the first chemical solution in the first chemical cleaning bath 220 into the second chemical cleaning bath 240 in which the second chemical solution is received after completing recovery cleaning for all the membrane module cassettes 101 to 105. Alternatively, the second chemical solution in the second chemical cleaning bath 240 may be pumped into the first chemical cleaning bath 220 in which the first chemical solution is received.

According to another embodiment of the present invention, as shown in FIG. 6, the cleaning apparatus of the present invention includes a neutralizing bath 260 to mix and neutralize the first and second chemical solutions from the first and second chemical cleaning baths 220 and 240 after completing recovery cleaning for all the membrane module cassettes 101 to 105. The cleaning apparatus may further include neutralizing pumps 270b to pump the first and second chemical solutions in the first and second chemical cleaning baths 220 and 240 into the neutralizing bath 260, respectively.

Consequently, with the apparatus and method for cleaning membrane modules according to the present invention, chemicals used in chemical cleaning of any one membrane module cassette can be utilized in chemical cleaning of another membrane module cassette, resulting in consumption of a relatively low amount of chemicals for recovery cleaning. Further, no additional chemicals for neutralizing processes are required, resulting in a reduction in cleaning costs. Furthermore, it is possible to minimize the number of neutralizing processes performed upon disposal of chemicals used in recovery cleaning, resulting in enhanced cleaning efficiency and cleaning rate.

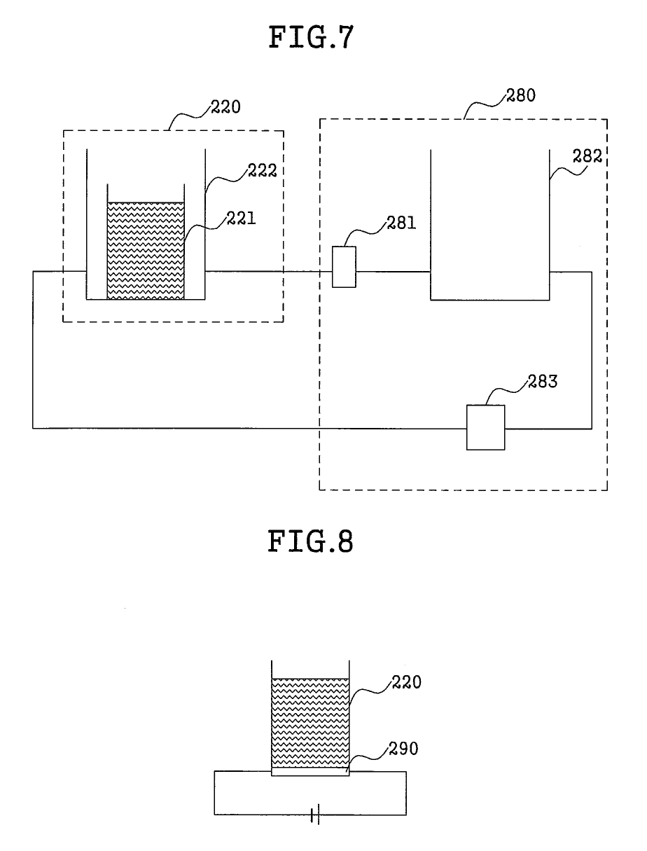

FIG. 7 is a view schematically illustrating a fluid circulating device for circulating fluid, such as chemical solutions and the like, used in the apparatus for cleaning membrane modules according to the present invention.

As shown in FIG. 7, the chemical cleaning bath 220 in the cleaning apparatus of the present invention may include an internal bath 221 in which a chemical solution is received, and an external bath 222 surrounding the internal bath 221. If the chemical solution is continuously supplied into the internal bath 221 and the internal bath 221 overflows, the overflowed chemical solution is discharged through an outlet (not shown) of the external bath 222. The discharged chemical solution is returned into the internal bath 221 via a fluid circulating device 280 of the present invention.

The configuration of the fluid circulating device 280 according to the present invention will now be described in more detail. The fluid circulating device 280 of the present invention may include a filter 281 to filter the chemical solution discharged from the chemical cleaning bath 220, a storage bath 282 to store the chemical solution filtered by the filter 281, and a circulating pump 283 to direct the chemical solution stored in the storage bath 282 into the chemical cleaning bath 220. With the overflow configuration of the chemical cleaning bath and the fluid circulating device 280, the chemical solution can be continuously purified during recovery cleaning.

Although not shown, the fluid circulating device 280 of the present invention can be alternatively applied to the flushing bath. Specifically, the cleaning apparatus of the present invention may further include a filtering device to filter a flushing solution discharged from the flushing bath, a storage device to store the flushing solution filtered via the filtering device, and a pump to direct the flushing solution stored in the storage device into the flushing bath.

FIG. 8 is a view schematically illustrating a fluid oscillator mounted in the chemical cleaning bath according to an embodiment of the present invention.

As shown in FIG. 8, the cleaning apparatus of the present invention may further include a fluid oscillator 290 to oscillate a chemical solution received in the chemical cleaning bath 220 or a chemical solution to be injected into the chemical cleaning bath 220. The fluid oscillator 290 may be an oscillating plate or ultrasonic wave generator affixed to the chemical cleaning bath 220. Using the fluid oscillator 290 can enhance cleaning effects for membrane modules in the chemical cleaning bath 220.

Although not shown, the fluid oscillator 290 of the present invention can be alternatively applied to the flushing bath. Specifically, the cleaning apparatus of the present invention may further include a fluid oscillating device to oscillate a flushing solution received in the flushing bath or a flushing solution to be injected into the flushing bath, resulting in enhanced flushing effect.

1. An apparatus for cleaning a membrane module comprising:
a first flushing bath for flushing a membrane module transferred from a water treatment tank; and
a first chemical cleaning bath for cleaning the membrane module, which has been flushed and transferred from the first flushing bath, by use of a first chemical solution.

2. The apparatus according to claim 1, further comprising:
a second flushing bath for flushing the membrane module which has been cleaned by use of the first chemical solution.

3. The apparatus according to claim 1, further comprising:
a second chemical cleaning bath for cleaning the membrane module, which has been cleaned by use of the first chemical solution, by use of a second chemical solution.

4. The apparatus according to claim 3, further comprising:
a second flushing bath for flushing the membrane module which has been cleaned by use of the second chemical solution in the second chemical cleaning bath.

5. The apparatus according to claim 3, further comprising:
an intermediate flushing bath for flushing the membrane module which has been cleaned by use of the first chemical solution, prior to cleaning the membrane module by use of the second chemical solution.

6. The apparatus according to claim 3, further comprising:
a neutralizing bath for mixing and neutralizing the first and second chemical solutions discharged from the first and second chemical cleaning baths, respectively,
wherein the first and second chemical solutions include a base solution and an acid solution, respectively.

7. The apparatus according to claim 1, further comprising:
a filtering device for filtering the first chemical solution discharged from the first chemical cleaning bath;
a storage device for storing the first chemical solution filtered via the filtering device; and
a pump for directing the first chemical solution, stored in the storage device, into the first chemical cleaning bath.

8. The apparatus according to claim 1, further comprising:
a filtering device for filtering a flushing solution discharged from the first flushing bath;
a storage device for storing the flushing solution filtered via the filtering device; and
a pump for directing the flushing solution, stored in the storage device, into the first flushing bath.

9. The apparatus according to claim 1, further comprising:
an oscillating device for oscillating a flushing solution in the first flushing bath.

10. The apparatus according to claim 1, further comprising:
an oscillating device for oscillating the first chemical solution in the first chemical cleaning bath.

11. A method for cleaning a membrane module comprising:
transferring a membrane module from a water treatment tank;
flushing the membrane module, transferred from the water treatment tank, in a first flushing bath; and
cleaning the membrane module, which has been flushed and transferred from the first flushing bath, in a first chemical cleaning bath by use of a first chemical solution.

12. The method according to claim 11, further comprising:
flushing the membrane module which has been cleaned by use of the first chemical solution.

13. The method according to claim 11, further comprising:
flushing the membrane module, which has been cleaned by use of the first chemical solution, in a second flushing bath.

14. The method according to claim 11, further comprising:
cleaning the membrane module, which has been cleaned by use of the first chemical solution, in a second chemical cleaning bath by use of a second chemical solution.

15. The method according to claim 14, further comprising:
flushing the membrane module which has been cleaned by use of the second chemical solution.

16. The method according to claim 14, further comprising:
flushing the membrane module, which has been cleaned by use of the second chemical solution, in a second flushing bath.

17. The method according to claim 14, further comprising:
flushing the membrane module in an intermediate flushing bath after the chemical cleaning in the first chemical cleaning bath and before the chemical cleaning in the second chemical cleaning bath.

18. The method according to claim 14, further comprising:
mixing and neutralizing the first and second chemical solutions from the first and second chemical cleaning baths,
wherein the first and second chemical solutions include a base solution and an acid solution, respectively.

19. The method according to claim 14, further comprising:
mixing and neutralizing the first and second chemical solutions, discharged from the first and second chemical cleaning baths, respectively, in a neutralizing bath,
wherein the first and second chemical solutions include a base solution and an acid solution, respectively.

20. The method according to claim 11, further comprising:
filtering a flushing solution discharged from the first flushing bath; and
directing the filtered flushing solution into the first flushing bath.

21. The method according to claim 11, further comprising:
filtering the first chemical solution discharged from the first chemical cleaning bath; and
directing the filtered first chemical cleaning solution into the chemical cleaning bath.

22. The method according to claim 11, wherein the step of flushing the membrane module in the first flushing bath includes oscillating a flushing solution in the first flushing bath.

23. The method according to claim 11, wherein the step of cleaning the membrane module in the first chemical cleaning bath includes oscillating the first chemical solution in the first chemical cleaning bath.

24. A method for cleaning a membrane module comprising:
flushing a first membrane module, transferred from a water treatment tank, in a first flushing bath; and
cleaning the flushed first membrane module in a first chemical cleaning bath by use of a first chemical solution; and
flushing a second membrane module, transferred from the water treatment tank, in the first flushing bath during the cleaning of the first membrane module in the first chemical cleaning bath.

25. The method according to claim 24, further comprising:
flushing the first membrane module, which has been cleaned by use of the first chemical solution, in a second flushing bath;
cleaning the second membrane module, which has been flushed in the first flushing bath, in the first chemical cleaning bath by use of the first chemical solution during the flushing of the first membrane module in the second flushing bath; and
flushing a third membrane module, transferred from the water treatment tank, in the first flushing bath during the cleaning of the second membrane module in the first chemical cleaning bath.

26. The method according to claim 25, further comprising:
cleaning the first membrane module, which has been flushed in the second flushing bath, in a second chemical cleaning bath by use of a second chemical solution;
flushing the second membrane module, which has been cleaned in the first chemical cleaning bath, in the second flushing bath during the cleaning of the first membrane module in the second chemical cleaning bath;
cleaning the third membrane module, which has been flushed in the first flushing bath, in the first chemical cleaning bath by use of the first chemical solution during the flushing of the second membrane module in the second flushing bath; and
flushing a fourth membrane module, transferred from the water treatment tank, in the first flushing bath during the cleaning of the third membrane module in the first chemical cleaning bath.

27. The method according to claim 26, further comprising:
flushing the first membrane module, which has been cleaned by use of the second chemical solution, in a third flushing bath;
cleaning the second membrane module, which has been flushed in the second flushing bath, in the second chemical cleaning bath by use of the second chemical solution during the flushing of the first membrane module in the third flushing bath;
flushing the third membrane module, which has been cleaned in the first chemical cleaning bath, in the second flushing bath during the cleaning of the second membrane module in the second chemical cleaning bath;
cleaning the fourth membrane module, which has been flushed in the first flushing bath, in the first chemical cleaning bath by use of the first chemical solution during the flushing of the third membrane module in the second flushing bath; and
flushing a fifth membrane module, transferred from the water treatment tank, in the first flushing bath during the cleaning of the fourth membrane module in the first chemical cleaning bath.

28. The method according to claim 24, further comprising:
cleaning the first membrane module, which has been cleaned by use of the first chemical solution, in a second chemical cleaning bath by use of a second chemical solution;
cleaning the second membrane module, which has been flushed in the first flushing bath, in the first chemical cleaning bath by use of the first chemical solution during the cleaning of the first membrane module in the second chemical cleaning bath; and
flushing a third membrane module, transferred from the water treatment tank, in the first flushing bath during the cleaning of the second membrane module in the first chemical cleaning bath.

29. The method according to claim 28, further comprising:
flushing the first membrane module, which has been cleaned by use of the second chemical solution, in a second flushing bath;
cleaning the second membrane module, which has been cleaned in the first chemical cleaning bath, in the second chemical cleaning bath by use of the second chemical solution during the flushing of the first membrane module in the second flushing bath;
cleaning the third membrane module, which has been flushed in the first flushing bath, in the first chemical cleaning bath by use of the first chemical solution during the cleaning of the second membrane module in the second chemical cleaning bath; and
flushing a fourth membrane module, transferred from the water treatment tank, in the first flushing bath during the cleaning of the third membrane module in the first chemical cleaning bath.
